(19) United States
(12) Patent Application Publication
(10) Pub. No.: US 2014/0006039 A1
(43) Pub. Date: Jan. 2, 2014

(54) Health Care Index

(71) Applicants: Rohail Khan, South Barrington, IL (US); Jeffery Lanzet, Prospect, KY (US)

(72) Inventors: Rohail Khan, South Barrington, IL (US); Jeffery Lanzet, Prospect, KY (US)

(73) Assignee: Xerox Business Services. LLC, Dallas, TX (US)

(21) Appl. No.: 13/534,199

(22) Filed: Jun. 27, 2012

(51) Int. Cl. G06Q 50/22

(52) U.S. Cl. 705/2

(57) ABSTRACT

A healthcare management system for evaluating medical risk and health state of a consumer comprising a gateway configured to obtain clinical information and non-clinical information for the consumer, determine a composite healthcare index (HCI) for the consumer based on both the clinical information and non-clinical information, and share the composite HCI with a plurality of healthcare stakeholders that are authorized to receive the composite HCI, wherein the composite HCI is determined using a combination of a plurality of component HCI scores that are calculated using the clinical information and the non-clinical information.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The Patient Protection and Affordable Care Act (PPACA) is a United States federal statute signed into law as part of the healthcare reform legislation of the 111th United States Congress. The PPACA requires individuals not covered by employer or government-sponsored insurance plans to maintain minimal essential health insurance coverage, and is intended to reform some aspects of the private health insurance industry and public health insurance programs. The PPACA is also intended to increase insurance coverage of pre-existing conditions, expand access to insurance to about 30 million Americans, and increase projected national medical spending while lowering projected Medicare spending. Some provisions in the Act, such as meaningful use requirements and premium share for healthcare exchanges, require means for evaluating or measuring the clinical risk and health state of an individual, e.g., for coverage and cost determination. Currently, there is no standard measure that is universally used in the healthcare industry to serve this purpose.

### SUMMARY

In an embodiment, the disclosure includes a healthcare management system for evaluating medical risk and health state of a consumer comprising a gateway configured to obtain clinical information and non-clinical information for the consumer, determine a composite healthcare index (HCI) for the consumer based on both the clinical information and non-clinical information, and share the composite HCI with a plurality of healthcare stakeholders that are authorized to receive the composite HCI, wherein the composite HCI is determined using a combination of a plurality of component HCI scores that are calculated using the clinical information and the non-clinical information.

In another embodiment, the disclosure includes an apparatus for healthcare information management comprising a processor configured to obtain information about a consumer comprising clinical data and non-clinical data, determine a plurality of component HCI scores based on the clinical and non-clinical data, and determine a composite HCI score for the consumer based on a combination of the clinical data and non-clinical data and on a plurality of significance factors that indicate the statistical significance and reliability of the clinical data and non-clinical data.

In yet another embodiment, the disclosure includes a method implemented by a healthcare management information system, comprising calculating a plurality of consumer HCI scores for a plurality of healthcare consumers based on clinical data and additional non-clinical data of the healthcare consumers; calculating a plurality of aggregate HCI scores for a plurality of healthcare stakeholders based on tracking the consumer HCI scores over time; and sharing the consumer HCI scores and the aggregate HCI scores with at least some of the healthcare consumers and the healthcare stakeholders that are authorized to access the consumer HCI scores and the aggregate HCI scores.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a HCI information management system.

FIG. 2 is a schematic diagram of an embodiment of a HCI determination scheme.

FIG. 3 is a schematic diagram of an embodiment of a HCI determination scenario.

FIG. 4 is a flowchart of an embodiment of a flowchart of a HCI determination method.

FIG. 5 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Typically, a healthcare service involves an individual, a provider, and a payer. The individual (also called a consumer) may be a patient, and the provider may be a healthcare trained professional (e.g., a doctor) or a group of professionals (e.g., at a healthcare service center) that attends to the healthcare needs of the individual. The individual may also be a subscriber or consumer who is a member of a healthcare plan that is offered by a payer, e.g., an insurance carrier. The payer or insurance carrier may be a private or public (e.g., government owned) healthcare insurance provider that covers at least some of the healthcare service cost for the individual (e.g., the patient). A group of individuals may also be members of the same group plan offered by an employer, such as a group of employees under the same employer, which may be members of a group plan offered by the employer as plan sponsor using the services of a payer.

The payer may cover individual subscribers or consumers, which may have individual or family plans, and/or group subscribers, which may have employer group plans. The payer may pay the provider at least some of the cost for attending to the healthcare needs of the individuals. Payers may need to evaluate the clinical risk and health state of the individual before approving or paying the provider for treating the individual. This evaluation may be necessary to the payer for cost assessment and financial risk purposes, where paying for individuals that have higher clinical risk (e.g., chronically or terminally ill patients) and/or lower health state (e.g., older patients) may be financially riskier for the payer or employer as the plan sponsor. The payer may need to use an evaluation measure for the clinical risk and health state that meets the provisions and requirements of the PPACA.

Currently, there are no robust and complete standard measures that are universally or widely used across the healthcare industry for assessing the clinical risk and health state of individuals or patients. Previous clinical risk and health state measures have been used (e.g., proprietarily) by individual stakeholders in the healthcare system in attempts to quantify the clinical risk and health state for individuals. For example, some providers of disease management may employ measures that indicate if an individual is a candidate for treatment of a specific chronic condition or a combination of conditions. Some providers of health risk assessments may report their results in the form of a health score. Different measures may be used to report the quality of healthcare providers. These measures may be specific to a single purpose, limited in scope, and/or not be broadly accepted or implemented.

Disclosed herein is a system and method for providing a measure for evaluating the clinical risk and health state of an individual, referred to herein as a HCI, which may be suitable for universal or substantial wide use in the healthcare industry. The HCI may serve as a standard and may be used by a plurality of different stakeholders in the healthcare system, such as healthcare providers, payers, employers, and individuals, to meet provisions in the PPACA and other relevant regulations that require such evaluation. The HCI may also be used to improve the operations and reduce the cost of healthcare for each of these stakeholders. The HCI may include detailed information about the individual to reflect with sufficient objectivity, accuracy, and fairness the clinical risk and the health state of the individual.

The information may include clinical and medical records of the individual combined with additional information that may also be relevant to the health state of the individual. The additional information may comprise demographics information, information about the individual's utilization of healthcare and adherence to care plans and instructions, information about how efficient the individual is as a consumer of healthcare, information about the individual's readiness to change habits (e.g., for improving health), individual's lifestyle information, or combinations thereof. Each of these factors or components may be evaluated by a corresponding component HCI, and the resulting component HCI values may be combined into a composite or overall HCI. The overall HCI may reflect the value of all the considered components or factors. The different HCI components may also be weighted differently when combined to obtain the composite HCI, such as to place more emphasis on some components that may be more relevant or statistically significant to the evaluation.

Additionally, the HCI scores may be tracked for individuals to evaluate healthcare providers and payers in terms of healthcare service value and quality delivered to patients. For example, a provider HCI may be calculated based on an aggregation of individual HCI scores for individuals who utilize that specific provider. The individuals' HCI scores may also be tracked to evaluate healthcare payers in terms of provided coverage value and quality. For example, a payer score HCI may be calculated based on the aggregated HCI scores of individuals who utilize that specific payer.

The individuals may use their HCI scores and the providers' HCI scores to make informed decisions for selecting healthcare providers. Employers may use the HCI scores of their employees to manage financial risk by selecting healthcare plans appropriate for the employee population based on the individual attributes of each distinct plan that is responsible for driving the desired outcomes. The employees may also use the HCI scores of payers to select a suitable payer. The HCI scores of individuals may also be used by healthcare providers to evaluate patients and obtain healthcare relevant information about the patients. Healthcare payers may use the individual's HCI scores to determine the cost and degree of coverage for the individuals, e.g. the healthcare subscribers or consumers. Based on such determination, the payers may implement fair and cost effective decisions for approving/limiting coverage, which may help in reducing overall healthcare cost. The HCI scores for the individuals, providers, and payers may also be used by different stakeholders, such as federal/state governments, healthcare legislators and regulating authorities, payers, providers, and/or others, to focus resources, incentives, and/or target programs to promote overall healthcare improvement.

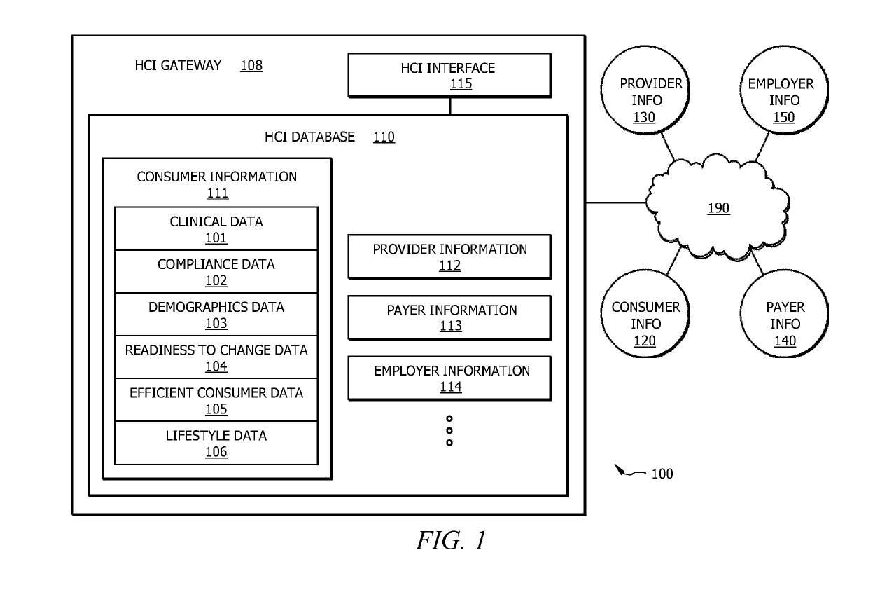

FIG. 1 illustrates an embodiment of a HCI information management system 100 for determining and sharing the HCI scores for different healthcare stakeholders. The HCI information management system 100 may comprise a HCI gateway 108, which may be located at a server or other physical box (not shown), such as a general-purpose computer. Alternatively, the HCI gateway 108 may be distributed at a plurality of nodes (e.g., in one or more networks), a plurality of servers or network interface cards (NICs) (e.g., in one or more data centers), or other suitable distributed architectures and components. The HCI gateway 108 may comprise an HCI database storage 110 and a HCI interface 115, and may be coupled via one or more networks 190 to a plurality of stakeholder entities. The stakeholders' entities may comprise one or more consumer information systems 120, one or more provider information systems 130, one or more payer information systems 140, and one or more employer information systems 150.

The HCI database storage 110 may be any storage component configured to maintain digital data. For example, the HCI database storage 110 may correspond to one or more hard disks, temporary memory devices, portable memory devices, other digital data storage technologies, or combinations thereof. The storage devices or components of the HCI database storage 110 may be located at a single server (e.g., a physical box) or may be distributed (e.g., in a data center or a network). The HCI database storage 110 may maintain consumer information 111, provider information 112, payer information 113, employer information 114, and optionally other information (e.g., government/regulating authority information), which may be obtained from the stakeholders.

The HCI gateway 108 may obtain the consumer information 111 that comprises data about healthcare consumers (e.g., individual consumers of healthcare plans and employees). The consumer information 111 may be used to calculate HCI scores for the consumers and other stakeholders. The consumer information 111 may comprise clinical data 101, compliance data 102, demographics data 103, readiness to change data 104, efficient consumer data 105, and lifestyle data 106 for the consumers. The clinical data 101 may comprise clinical and medical information for each considered consumer. For example, the clinical data 101 may comprise the consumer's medical records, claims data, prescription records, biometric data, lab result data, diagnostic, procedure and other codes, clinical visits records, and similar information for the consumers. The compliance data 102 may comprise information that indicates the consumer's level of adherence to treatment programs (e.g., therapy and medication) and maintenance of clinical visits and recommendations. For example, the compliance 102 data may comprise demographic information, self-reported data, claims data, diagnostic, procedure and other codes, history records and logs that reveal the consumer's regular clinical visits, filling of prescriptions, or lack thereof.

The demographics data 103 may indicate the consumer's demographic information, such as age, gender, race, location, personal background, and other relevant information specific to the consumer. Demographics data 103 may also include health plan eligibility, enrollment, and participation information. The readiness to change data 104 may indicate the consumer's willingness for change (e.g., in term of habits, lifestyle, or behavior), e.g., to achieve better health state and wellness. For example, the readiness to change data 104 may include pattern changes, such as quitting of smoking, weight loss, starting new activities, new gym membership, and other information indicative of the consumer's flexibility to act to improve or maintain health, e.g., based on health program or doctor recommendations. Readiness to change data 104 may also include the results of a survey or surveys taken by the individual that provide information related to the individuals readiness to change. The efficient consumer data 105 may indicate how well a consumer consumes healthcare services and products (e.g., how good a shopper for healthcare services and products the consumer is) and include claim data, self-reported data, and healthcare eligibility, enrollment and participation data. For example, the efficient consumer data 105 may indicate whether the consumer purchases generic or brand name products (e.g. prescription drugs) and whether the consumer visits in-network or out-of-network providers or other usage indicators of efficient consumer behavior. The lifestyle data 106 may indicate lifestyle or habits and choices of the consumer, such as wearing seat belts or using sunscreen. The lifestyle data 106 may include self-reported data from a survey or surveys including health risk assessments and other survey instruments.

The provider information 112 may comprise information about providers, such as the consumers and payers associated with the providers, records of consumers' visits to the providers, payment and claim records from the payers, and other relevant healthcare and contact information for the providers. The payer information 113 may comprise information about payers, such as the consumers, employers, and providers associated with the payers, the payment records of the payers, and other relevant healthcare and contact information for the payer. The employer information 114 may comprise information about employers, such as the consumers and payers associated with the employers, the payment records for the employer's employees (the consumers), and other relevant healthcare and contact information for the employers.

In some cases, the HCI database storage 110 may maintain government/regulating authority information, which may include healthcare requirement and regulation information by federal/state governments and public/private regulating agencies. Such information may include evidence based medicine guideline and meaningful use information required by the Centers for Medicare and Medicaid Services (CMS) under the PPACA, information required by PPACA for healthcare exchange premium share requirements, and other regulations. The government/regulating authority information may be used to determine HCI scores for consumers and other stakeholders. The government/regulating authority may be relevant to evaluating the providers' quality of service and the payers' compliance to rules and regulations. For example, the government/regulating authority information may include numerical criteria, standards, thresholds, and data that may be used in the calculation of HCI values.

The HCI interface 115 may be any component configured to receive and process the consumer information 111 to determine HCI values, including component HCI scores and overall or composite HCI scores for consumers, as described below. The HCI interface 115 may be configured to receive and process the provider information 112, payer information 113, and employer information 114, and to determine HCI scores for providers, payers, and employees. The HCI interface 115 may also be configured to share some or all of the determined HCI scores with different stakeholders, such as sharing the consumers' HCI scores with the providers, payers, employers, and/or employees, and sharing the HCI scores for providers and/or payers with the employers, employees, and/or consumers. The HCI interface 115 may comprise a transmitter/receiver or transceiver (not shown) that exchanges information with the other components of the HCI information management system 100, and one or more central processing units or CPUs (not shown) for processing the exchanged information.

The HCI gateway 108 may obtain the consumer information 111, provider information 112, payer information 113, and employer information 114 by communicating, via the one or more networks 190, with the consumer information system(s) 120, the provider information system(s) 130, the payer information system(s) 140, and the employer information system(s) 150, respectively. The consumer information system(s) 120, provider information system(s) 130, payer information system(s) 140, and employer information system(s) 150 may be one or more database management systems that collect, maintain, and forward such information to the HCI database storage 110. The consumer information system(s) 120, provider information system(s) 130, payer information system(s) 140, and employer information system(s) 150 may be owned and managed by the same or different entities (e.g., third parties). Additionally, the HCI gateway 108 may obtain the may obtain, e.g., via the network(s) 190, government/regulating authority information from one or more government/regulating authority systems or databases.

The one or more networks 190 may be any network(s) that communicate(s) with and allow(s) communications between the HCI gateway 108 and the stakeholders' entities. The network(s) 190 may comprise one or a plurality of access/transport networks that may be based on one or more network transport technologies and protocols including batch and real time transportation mechanisms. Examples of the network(s) 190 may include the Internet, Ethernet networks, optical backbone networks, digital subscriber line (DSL) networks, local area networks (LANs), wireless area networks (WANs), other types of telecommunication networks, or combinations thereof.

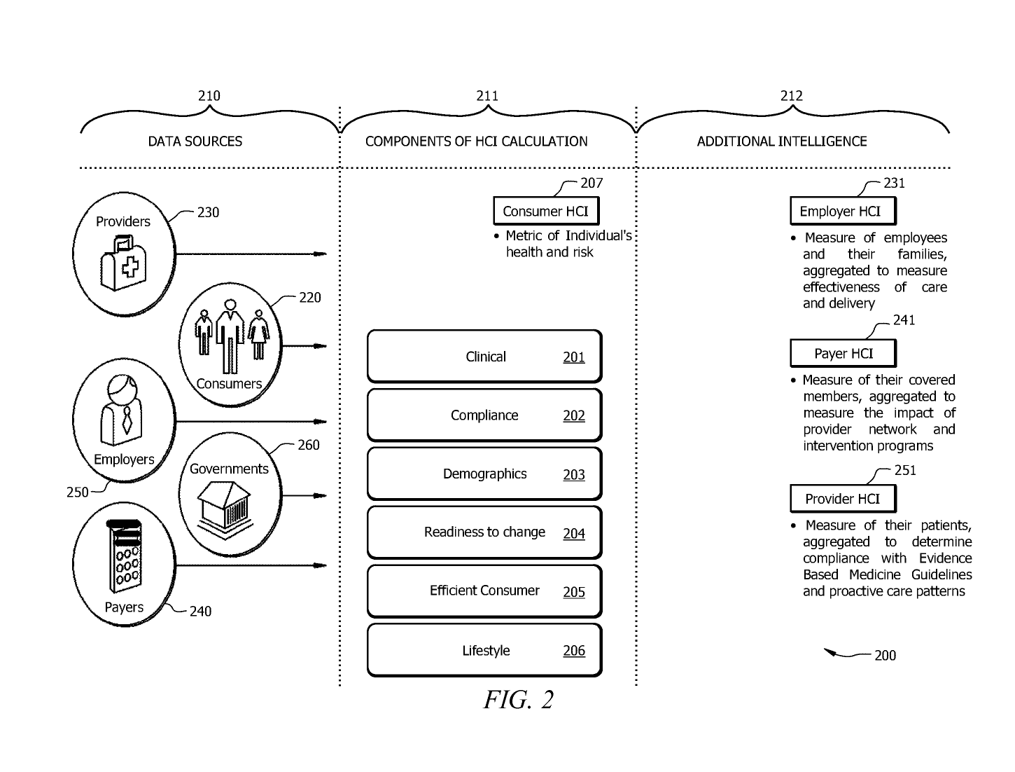

FIG. 2 illustrates an embodiment of a HCI determination scheme 200, which may be implemented, e.g., in the HCI information management system 100, the HCI gateway 108, or the HCI interface 115, to determine HCI scores for individuals (or consumers), payers, providers, employers, governments (and regulating authorities), or combinations thereof. The HCI scores may be determined or calculated based on a plurality of data sources 210. The data sources 210 may be obtained from any number of consumers 220, providers 230, payers 240, employers 250, governments (and regulating authorities) 260, or combinations thereof. The information obtained from the data sources 210 may be used to determine a plurality of component HCI values 211 (components of HCI calculation). The component HCI values 211 may comprise a clinical HCI 201, a compliance HCI 202, a demographics HCI 203, a readiness to change HCI 204, an efficient consumer HCI 205, a lifestyle HCI 206, or combinations thereof. The component HCI values 211 may then be used to calculate a composite or overall consumer HCI 207. The data sources 210 and/or the component HCI values 211 may also be used to determine additional intelligence information 212, including a provider HCI 251, a payer HCI 241, an employer HCI 231, or combinations thereof.

The overall consumer HCI 207 may be used by the providers 230, payers 240, employers 250, and/or governments 260 as a metric for the individual's health and risk to evaluate and/or improve the health state of the consumer 220. The overall consumer HCI 207 may also be tracked (e.g., over a proper period of time) to measure the improvement or deterioration in the consumer's health state. This HCI may be used by the different healthcare stakeholders as a universal or standard measure for various reporting requirements and for underwriting healthcare. The component HCI values 211 may also be provided, e.g., with the overall consumer HCI 207, as part of the output and may be used to help understand the overall consumer HCI 207.

The clinical HCI 201 may be a measure of clinical risk based on consumer's medical records, claims data, prescription records, biometric data, lab result data, diagnostic, procedure and other codes, clinical visits records, and similar information for the consumers. Determining the clinical HCI may involve analyzing data to identify the presence of a health condition. For example, this may include identifying if an individual has a pre-chronic (e.g., pre-diabetic or pre-hypertensive) condition, chronic condition, acute condition, or end stage medical condition. Comorbid conditions may also be identified for this purpose. The result of the analysis may be used to assign the individual into a risk category and develop a score for this component, and may be used as input to the determination of scores for other components of HCI calculation. The presence or absence of evidence-based guidelines for preventative care may also be a factor in determining clinical risk. Inputs for the determination of the clinical HCI 201 may include consumer's medical records, claims data, prescription records, biometric data, lab result data, diagnostic, procedure and other codes, clinical visits records, and similar information for the consumers.

The compliance HCI 202 may be a measure of the individual's compliance and adherence to treatment plans and evidence based medicine guidelines. Inputs for the determination of the compliance HCI 202 may include demographic information, self-reported data (by the individual), claims data, diagnostic, procedure and other codes, history records and logs that reveal the consumer's regular clinical visits, filling of prescriptions, or lack thereof, and output of the clinical component analysis. The demographics HCI 203 may be a measure of risk based upon age, gender, and other socioeconomic factors. Inputs for the determination of the demographics HCI 203 may include consumer's demographic information, such as age, gender, race, location, personal background, self-reported data, and other relevant information specific to the consumer. Demographics data 103 may also include health plan eligibility, enrollment, and participation information.

The readiness to change HCI 204 may be a measure of the individual's behavior associated with readiness to engage with change. Inputs for the determination of the readiness to change HCI 204 may include self-reported data and outputs of the clinical, compliance, demographics, and lifestyle components analysis. Readiness to change data 104 may also include the results of a survey or surveys taken by the individual that provide information related to the individuals readiness to change. The efficient consumer HCI 205 may be a measure of the purchasing patterns of the individual, such as the use of generic drugs, use of self-service tools, and utilization of in-network and high quality providers. Inputs for the determination of the efficient consumer HCI 205 may include claims data, self-reported data and healthcare eligibility, enrollment and participation data. The lifestyle HCI 206 may be a measure of lifestyle choices, such as nutrition choices and exercise. Inputs for the lifestyle HCI 206 may include self-reported data from a survey or surveys including health risk assessments and other survey instruments.

In an embodiment, the calculations of the overall consumer HCI 207 may include using consumer's financial data (e.g., as part of the components 211), which may enable a health and wealth HCI model. The health and wealth HCI model may be a measure that helps individuals (or consumers) to balance the health and wealth aspects of their life, where medical and healthcare expenses may represent a significant amount of overall expenses over the lifetime of an individual. The health and wealth HCI model may provide a measure that allows an individual to evaluate health and wealth in a consolidated manner and to balance the two aspects to improve health and optimize or better control the individual's financial position.

The employer HCI 231 may be obtained by combining a plurality of consumer HCI values for a plurality of consumers (and their families or dependents) that may be associated with the same employer and tracking the combined HCI 207 or component HCI 211 (including clinical HCI 201, compliance HCI 202, demographics HCI 203, readiness to change HCI 204, efficient consumer HCI 205, and lifestyle HCI 206) values over time. For example, the consumer HCI 207 or component HCI values may be tracked over a plurality of months or years to determine whether an average consumer HCI 207 or component HCI values increase or decrease over that period. An increase in the average consumer HCI 207 value may translate into a higher employer HCI 231. Similarly, the payer HCI 241 and the provider HCI 251 may be obtained by combining the overall consumer HCI 207 or component HCI 211 (including clinical HCI 201, compliance HCI 202, demographics HCI 203, readiness to change HCI 204, efficient consumer HCI 205, and lifestyle HCI 206) values that may be associated with the same payer and provider, respectively, and tracking the combined HCI values over time. A higher average consumer HCI value over time may translate into higher payer HCI 241 and provider HCI 251 values. The payer HCI 241 may be used to evaluate and select payers that have superior track records in term of providing quality healthcare to and improving the health of consumers and identify specific aspects of payer service and capabilities that may demonstrate superior quality and value or may require improvement. The provider HCI 251 may be used to evaluate the provider's quality of provided healthcare services and to determine a compensation model for providers, e.g., based on the quality and efficacy of offered care. The employer HCI 231, payer HCI 241, and provider HCI 251 may also be used in evaluating compliance of employees, payers, and providers to requirements of the PPACA and other healthcare regulating authorities, such as the CMS. In an embodiment, additional information and measures e.g., on a per-provider or per-payer basis, may be used as part of determining the payer HCI 241 and provider HCI 251. For example, information or measures of a provider's compliance with evidence based medicine guidelines and/or of a payer's network penetration in a specific market may be collected. This additional data may be used to enhance the payer HCI 241 and provider HCI 251, e.g., in terms of accuracy and completeness.

To obtain the overall consumer HCI 207, each of the component HCI values 211 may be assigned a corresponding significance factor (a weighting factor) that may be based on or represent the statistical significance, quality, and reliability of the corresponding information. This may ensure that each component HCI value 211 is statistically significant and sufficiently objective, and determine the amount of impact of each component HCI value 211 on the overall consumer HCI 207. For example, the clinical HCI 201, which may be based on a broad range of claims and biometrics, may have a higher significance factor. The readiness to change HCI 204 and the lifestyle HCI 206, which may be based on consumer self-reported data, may have lower significance factor.

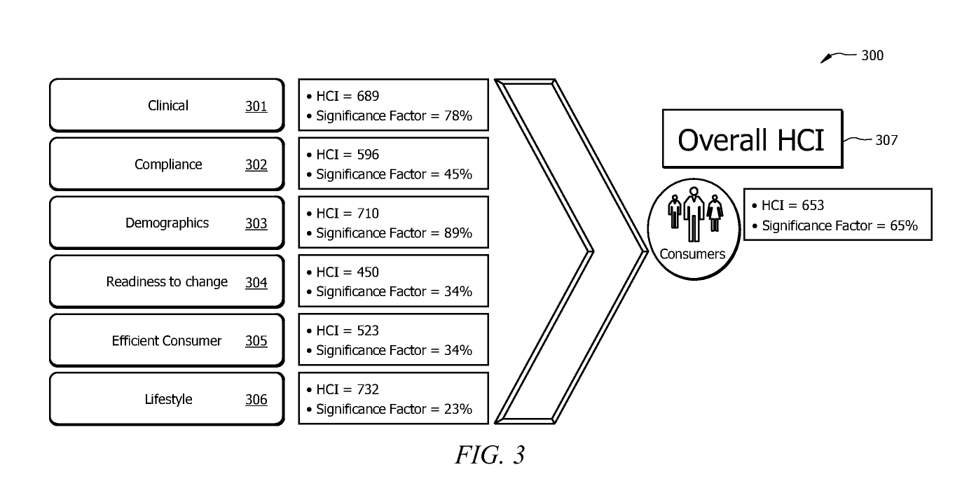

FIG. 3 illustrates an embodiment of a HCI determination scenario 300, which may be implemented using the HCI determination scheme 200. The HCI determination scenario 300 may be implemented to determine an overall consumer HCI 307 based on a combination of weighted component HCI scores. The component HCI scores may comprise a clinical HCI 301, a compliance HCI 302, a demographics HCI 303, a readiness to change HCI 304, an efficient consumer HCI 305, and a lifestyle HCI 306. As described above, the component HCI scores may be assigned corresponding significance factors to represent the accuracy, quality, reliability, and objectivity of the different components. For example, the calculated clinical HCI 301 may have a value of 689 and may be assigned a relatively high significance factor of 78 percent since the input data used to calculate this component may be based on reliable sources (e.g., medical claims and accurate biometric data for the individual). The calculated readiness to change HCI 304 may have a value of 450 and may be assigned a relatively low significance factor of 34 percent since the input data used to calculate this component may be based on less reliable sources (e.g., self-reported data).

The component HCI scores may be normalized or scaled to have about equal weight in determining the overall consumer HCI 307, without including the significance factors. Thus, when each component HCI is multiplied (or combined in other manner) with a corresponding significance factor (e.g., some percentage value), each component HCI may be scaled appropriately based on the reliability, quality, and objectivity of the associated data. The component HCI scores and the corresponding significance factors may be combined (e.g., as a weighted sum) to obtain a scaled or normalized overall consumer HCI 307. For example, the sum (or combination in other manner) of the component HCI scores in FIG. 3 (weighted by their corresponding significant factor percentages) provides a scaled overall consumer HCI 307 of about 653. An overall significance factor of about 65 percent may also be calculated based on the component significant factors and may reflect the accuracy, quality, reliability, and statistical significance of the overall consumer HCI 307.

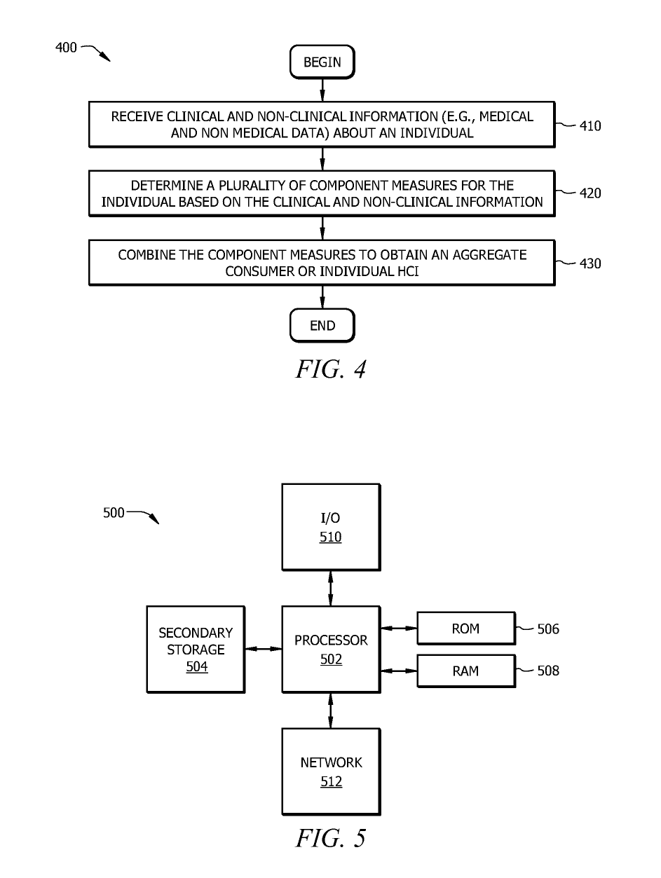

FIG. 4 illustrates an embodiment of a HCI determination method 400 that may be implemented, e.g., in the HCI information management system 100, the HCI gateway 108, or the HCI interface 115, to determine a consumer HCI based on a plurality of component HCI scores. The HCI determination method 400 may be implemented as part of the HCI determination scheme 200. The method 400 may begin at block 410, where clinical and non-clinical information (e.g., medical and non-medical data) may be received about an individual. The individual's clinical and non-clinical information may correspond to or include the consumer information 111.

For example, the clinical and non-clinical information may include eligibility to participate in various health plans and programs, enrollment in health plans and programs, demographics, absenteeism, medical claims, pharmacy claims, disability claims, spending accounts claims, patient test results, or combinations thereof. The clinical and non-clinical data may also include evidence-based compliance, meaningful use compliance, lifestyle information, consumer preferences, patterns of healthcare purchases, supplemental medical information (e.g., about allergies), family history, biometrics, health risk assessments, or combinations thereof. Further, the clinical and non-clinical data may include information required from the states by CMS as part of the meaningful use definition, information required per PPACA for enabling premium share in healthcare exchanges, financial information, such as regarding savings, pension, information related to both healthcare and overall personal spending and expense, or combinations thereof.

At block 420, a plurality of component measures may be determined for the individual based on the clinical and non-clinical information. The component measures may correspond to or include the component HCI values 211. For example, the component measures may comprise HCI values for health state and clinical risk, compliance with treatment plans, clinical risk that may be based on known demographic factors that impact health risk, readiness for change, ability to make efficient healthcare purchasing decisions, lifestyle choices that may relate to health, or combinations thereof. At block 430, the component measures may be combined to obtain an overall consumer (or individual) HCI, such as the overall consumer HCI 207. The component measure may be combined as a weighted sum (or using some other suitable function) based on a plurality of corresponding significant factors (e.g., multipliers) that reflect the reliability and accuracy of the component measures. The method 400 may then end.

In an embodiment, determining the clinical HCI may comprise the analysis of medical records, medical dental and vision claims data, prescription records, biometric data, lab result data, clinical visits records, and similar information to identify the presence of a health condition. Healthcare industry codes may also be used if available, such as the International Statistical Classification of Diseases and Related Health Problems (ICD), Current Procedural Terminology (CPT), Diagnosis-related group (DRG), Charlson Index codes, and other healthcare industry codes. The identification of a medical condition along with the acuity of the medical condition may result in a lower clinical HCI score. The presence of medications prescribed for a medical condition may be considered as evidence of that medical condition, taking into account off-label uses of determined or selected medications. The healthcare industry codes may be translated to identify chronic conditions and history of acute conditions. Chronic conditions may become semi-permanent on the record. If a presence of a chronic condition is indicated, the medical claims may be analyzed to determine how well the condition is or is not managed. The claims may also be analyzed to identify the severity or acuity of a condition and evidence that a chronic or acute condition has been corrected. The clinical HCI may be assigned based on the presence and severity of identified medical conditions.

Further, as part of the determination, the frequency of preventative care may be associated with lower risk, and the frequency of hospital visits may be associated with higher risk. A table lookup may also be used to associate medications that are identified from prescription claims with medical conditions. The prescription claims may be cross-validated with medical claims data when off-label use of medications is likely. Determining the clinical HCI may also comprise the analysis of biometric data, such as height, weight, waist circumference, blood sugar, blood pressure, cholesterol, lab results, and/or other measures if available to identify the presence of clinical conditions. Biometric data may be compared with guidelines to identify the presence of health conditions or risk for determined medical conditions.

Determining the compliance HCI may comprise identifying compliance with evidence-based guidelines for preventative care and screenings, such as prostate, mammogram, colonoscopy, etc. Compliance with guidelines for preventative care and recommended screenings may result in a higher compliance HCI score. Determining the compliance HCI may also comprise identifying compliance with evidence based guidelines for treatment of medical conditions for individuals for whom a condition was identified during the clinical component analysis. The compliance with treatment programs may result in a higher compliance HCI score. The analysis may comprise identifying screenings appropriate for age/gender and analyzing data for indications that the appropriate screenings have been performed. The analysis may also comprise identifying the presence of a medical condition based on the clinical component analysis and analyzing data for compliance with evidenced based guidelines for treatment plans.

Determining the demographics HCI may comprise associating clinical risk with age, gender, race, income, geography, marital status, religion, education, and/or family composition. Participating in appropriate medical/dental/vision plans may be associated with a lower risk, and hence a higher demographics HCI. Actuarial tables, scientifically valid surveys, and proven correlations between demographic information and health risk may be used to assign a health risk score based on demographics. Participation in health plans may also be used to assign a risk score based on participation and duration proportionate with age/gender and family composition.

Determining the readiness to change HCI may comprise evaluating individuals, which may be identified as being high-risk in the clinical, compliance, demographics and/or lifestyle categories, based on a readiness to change survey. The risk may be associated with the individuals' stage of readiness to change based on a determined model, such as “The Trans-theoretical Model of Behavior Change” by James O. Prochaska, which is incorporated herein by reference as if reproduced in its entirety. A risk score for the readiness to change component may be based on the level of clinical, compliance, demographics, and/or lifestyle risk and stage of readiness to change. A plurality of readiness to changes stages may be considered, such as pre-contemplation, contemplation, preparation, action, and maintenance.

Determining the efficient consumer HCI may comprise identifying individuals who employ practices or exhibit behaviors as more efficient consumers of healthcare. The analysis may include analyzing claims data and self-reported data that identify actions associated with good consumer behavior, such as the use of generic or over-the-counter (OTC) medications if available and appropriate. Such actions may also include commodity shopping for high-volume and readily available services with low quality variation, in-network versus out-of-network utilization, participation in healthcare plans and programs, and/or utilization of high-performance networks and quality providers. The actions may also include the use of Flexible Spending Account (FSA), Health Reimbursement Account (HRA), and/or Health Savings Account (HSA) plans, and the use of healthcare consumer based self-service tools.

Determining the lifestyle HCI may comprise identifying individuals who exhibit determined behaviors as having lower clinical risk. The analysis may use indicators associated with validated correlation to clinical risk. For example, self-reported data on stress, nutrition, exercise, sunscreen use, seat-belt use, smoking, alcohol consumption, drug use, and/or other risky behaviors may be associated with a risk score for the lifestyle component.

As described above, the HCI (e.g., overall consumer HCI) may be used individually for a consumer, or may be aggregated for an employer (e.g., for a group of employees), a provider (e.g., for multiple consumers associated with the provider), and a payer (e.g., for multiple consumers under the payer). The individual (consumer) and aggregate HCI scores may be used for different activities and actions, such as to help employers reduce the financial risk of providing healthcare. The HCI scores may also be used to identify the health state and clinical risk for individuals to drive treatment programs, and for groups of individuals to identify patterns of health risk in a determined population and design programs to improve the health of such populations. The HCI scores may also be used for recommending providers and carriers/payers best suited to the health state and clinical risk of an individual and their family members, providing incentives to drive healthy behaviors, comparing healthcare providers, and comparing healthcare networks and healthcare plans. The activities and actions for using the HCI scores may also include allowing members to assess value of providers and care delivery systems, complying with the meaningful use requirements of PPACA, enable premium share for healthcare exchanges, and optimizing healthcare spending for individuals, employers, and government entities, such as CMS.

The uses of the HCI scores may also include improving productivity in the workplace, compensating providers based on value of care and outcomes, optimizing payer reimbursements, optimizing Medicare and Medicaid reimbursements, assisting providers with the provision of healthcare, and reducing administrative fees associated with healthcare. Other uses may include creating an objective measure for payer reimbursement for value-based models, e.g., including Accountable Care Organizations (ACOs), enabling insurers to accurately predict and estimate risk and determine premiums, creating a mechanism for portability for underwriting healthcare risk, and allocating income and rewards between health spending and savings.

The uses of the HCI score may involve information protected under the Health Insurance Portability and Accountability Act (HIPAA) and other regulations. The information used may fall under safe-harbors for the operation of health plans. The information may be used by a third party, which may own or manage the HCI information management system 100, for instance on behalf of employers. However, at least some of the information may not be available to or known to employers. Using the significance factor (for both the component and overall HCI values) may ensure that the HCI is used appropriately. For example, when critical decisions (e.g., underwriting or eligibility for medical plans or programs) are based on the HCI, a low significance factor may prompt the solicitation of additional data, so that no critical decisions are based on scores that are not statistically significant.

The components described above may be implemented on any general-purpose network component, such as a computer or mobile device with sufficient processing power, memory resources, and network throughput capability to handle the necessary workload placed upon it. FIG. 5 illustrates a typical, general-purpose network component 500 suitable for implementing one or more embodiments of the components disclosed herein. The network component 500 includes a processor 502, e.g., a central processing unit (CPU), which is in communication with memory devices including secondary storage 504, read only memory (ROM) 506, random access memory (RAM) 508, input/output (I/O) devices 510, and network connectivity devices 512. The processor 502 may be implemented as one or more central processing unit (CPU) chips, or may be part of one or more application specific integrated circuits (ASICs) and/or digital signal processors (DSPs). The processor 502 may be configured to implement or support the HCI determination method 400 and/or the HCI determination scheme 200.

The secondary storage 504 is typically comprised of one or more disk drives or tape drives and is used for non-volatile storage of data and as an over-flow data storage device if RAM 508 is not large enough to hold all working data. Secondary storage 504 may be used to store programs that are loaded into RAM 508 when such programs are selected for execution. The ROM 506 is used to store instructions and perhaps data that are read during program execution. ROM 506 is a non-volatile memory device that typically has a small memory capacity relative to the larger memory capacity of secondary storage 504. The RAM 508 is used to store volatile data and perhaps to store instructions. Access to both ROM 506 and RAM 508 is typically faster than to secondary storage 504.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 7, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 7 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A healthcare management system for evaluating medical risk and health state of a consumer, comprising:
a gateway configured to obtain clinical information and non-clinical information for the consumer, determine a composite healthcare index (HCI) for the consumer based on both the clinical information and non-clinical information, and share the composite HCI with a plurality of healthcare stakeholders that are authorized to receive the composite HCI,
wherein the composite HCI is determined using a combination of a plurality of component HCI scores that are calculated using the clinical information and the non-clinical information.

2. The healthcare management system of claim 1, wherein the gateway comprises:
an interface configured to exchange the clinical information and non-clinical information with the healthcare stakeholder systems that are authorized to share the clinical information and non-clinical information; and
a database configured to store and maintain the clinical information and non-clinical information.

3. The healthcare management system of claim 2, wherein the interface is further configured to obtain healthcare stakeholder information from the healthcare stakeholder systems, wherein the database is further configured to store and maintain the healthcare stakeholder information, and wherein the healthcare stakeholder information comprises information about an employer of the consumer, information about a healthcare provider of the consumer, and information about a healthcare payer of the consumer.

4. The healthcare management system of claim 1, wherein the clinical information and non-clinical information comprise:
clinical data that indicates clinical and clinical information for the consumer;
compliance data that indicates the consumer's level of adherence to treatment programs and maintenance of clinical visits and recommendations;
demographics data that indicates the consumer's demographic information, including age, gender, and location;
readiness to change data that indicates the consumer's willingness for habit and behavior change;
efficient consumer data that indicates how efficient the consumer consumes healthcare services and products; and
lifestyle data that indicates lifestyle, habits, and choices of the consumer.

5. The healthcare management system of claim 1, wherein the component HCI scores comprise:
a clinical HCI that is a measure of the consumer's clinical risk;
a compliance HCI that is a measure of the consumer's compliance and adherence to medical treatment and guidelines;
a demographics HCI that is a measure of the consumer's risk based on age, gender, and socioeconomic factors;
a readiness to change HCI that is a measure of the consumer's behavior associated with readiness to engage with change;
an efficient consumer HCI that is a measure of the consumer's purchasing patterns; and
a lifestyle HCI that is a measure of the consumer's lifestyle choices regarding health.

6. The healthcare management system of claim 5, wherein the component HCI scores are combined with a plurality of corresponding significance factors to determine the composite HCI for the consumer, and wherein the significance factors represent the statistical significance and reliability of the corresponding clinical information and non-clinical information.

7. The healthcare management system of claim 6, wherein the significance factors are combined to determine a composite significance factor that indicates the accuracy, reliability, and statistical significance of the composite HCI score.

8. The healthcare management system of claim 1, wherein the clinical information and non-clinical information comprise financial data of the consumer, and wherein the component HCI scores comprise a health and wealth HCI that is determined using the financial data and is a measure of balance between health and wealth aspects of the consumer life.

9. The healthcare management system of claim 1, wherein the healthcare stakeholder systems are coupled to the gateway via one or more networks and comprise at least one of:
a consumer information source configured to exchange with the gateway at least some of the clinical information and non-clinical information for the consumer;
an employer source configured to exchange with the gateway information about an employer of the consumer;
a payer source configured to exchange with the gateway information about a healthcare payer of the consumer;
a provider source configured to exchange with the gateway information about a healthcare provider of the consumer; and
a government/regulating authority source configured to exchange with the gateway healthcare regulations for the consumer, the consumer's employer, insurance carrier, healthcare provider, or combinations thereof.

10. An apparatus for healthcare information management comprising a processor configured to:
obtain information about a consumer comprising clinical data and non-clinical data;
determine a plurality of component healthcare index (HCI) scores based on the clinical and non-clinical data; and
determine a composite HCI score for the consumer based on a combination of the clinical data and non-clinical data and on a plurality of significance factors that indicate the statistical significance and reliability of the clinical data and non-clinical data.

11. The apparatus of claim 10, wherein the processor is further configured to aggregate a plurality of composite HCI scores for a plurality of consumers to determine a payer HCI score for a healthcare payer of the consumers, a provider HCI score for a healthcare provider of the consumers, and an employer HCI score for an employer of the consumers.

12. The apparatus of claim 11, wherein the aggregated composite HCI scores for the consumers are tracked over a determined period of time to determine the payer HCI score, the provider HCI score, and the employer HCI score.

13. The apparatus of claim 11, wherein the composite HCI scores are shared with the healthcare payer, the healthcare provider, and the employer of the consumers.

14. The apparatus of claim 11, wherein the composite HCI scores are used by the healthcare payer to assess the clinical risk of the consumers, by the healthcare provider to evaluate the health state of the consumers, and by the employer to determine a suitable healthcare plan for the consumers.

15. The apparatus of claim 11, wherein the provider HCI score is shared with the healthcare payer and the payer HCI score is shared with the employer.

16. The apparatus of claim 11, wherein the provider HCI score is used by the healthcare payer to evaluate the quality and efficacy of offered care by the provider, and wherein the payer HCI score is used by the employer to evaluate the provider in term of providing quality healthcare for the consumers.

17. A method implemented by a healthcare management information system, comprising:
calculating a plurality of consumer healthcare index (HCI) scores for a plurality of healthcare consumers based on clinical data and additional non-clinical data of the healthcare consumers;
calculating a plurality of aggregate HCI scores for a plurality of healthcare stakeholders based on tracking the consumer HCI scores over time; and
sharing the consumer HCI scores and the aggregate HCI scores with at least some of the healthcare consumers and the healthcare stakeholders that are authorized to access the consumer HCI scores and the aggregate HCI scores.

18. The method of claim 17, wherein the healthcare stakeholders comprise a plurality of providers and a plurality of payers for the healthcare consumers, and wherein the consumer HCI scores and the aggregate HCI scores are used to evaluate the quality of healthcare offered by the providers and the payers to the healthcare consumers.

19. The method of claim 18, wherein the quality of healthcare offered by the providers and payers is evaluated to determine whether the quality of healthcare offered to the healthcare consumers meets a plurality of Patient Protection and Affordable Care Act (PPACA) regulations and a plurality of other government/regulating authority guidelines, including the Centers for Medicare and Medicaid Services (CMS) guidelines.

20. The method of claim 17, wherein the consumer HCI scores are used universally as a standard for all the healthcare stakeholders to evaluate quality of healthcare offered, focus healthcare resources, and target programs to promote healthcare improvement.
